(19) United States
(12) Patent Application Publication
(10) Pub. No.: US 2026/0084040 A1
(43) Pub. Date: Mar. 26, 2026

(54) ENCLOSURE FOR EQUIPMENT AND METHOD OF USE

(71) Applicant: Unbound Outdoor LLC, Golden, CO (US)

(72) Inventors: Richard Eveland Riegel, IV, Bedford Hills, NY (US); Sophia Ann Wubben, Golden, CO (US)

(21) Appl. No.: 19/338,994

(22) Filed: Sep. 24, 2025

Related U.S. Application Data
(60) Provisional application No. 63/698,310, filed on Sep. 24, 2024.

(51) Int. Cl. A63C 11/02; A45C 13/02; A45C 13/10; A45C 13/30; A45C 13/36; A45F 3/02; A45F 3/04; B60R 9/12

(52) U.S. Cl. CPC A63C 11/025; A45C 13/103; A45C 13/30; A45C 13/36; A45F 3/02; A45F 3/04; A63C 11/027; B60R 9/12; A45C 2013/026

(57) ABSTRACT

In accordance with one embodiment of the present disclosure, an enclosure for equipment is described. The enclosure can include a body that defines an outer surface and encloses an interior. The body can have a longitudinal axis the extends between a first end of the body and a second end of the body opposite the first end. The interior can include first, second, and third compartments that are disposed in series along the longitudinal axis. The first compartment can have a first cross-sectional area, the second compartment can have a second cross-sectional area, and the third compartment can have a third cross-sectional area, with the second cross-sectional area being larger than the first and third cross-sectional areas. The enclosure can also include an opening that extends across at least a portion of one of the first, second, and third compartments.

### CROSS-REFERENCE TO RELATED APPLICATIONS

The present application claims the benefit of, and priority to, U.S. Provisional Patent Application No. 63/698,310, filed Sep. 24, 2024, entitled “ENCLOSURE FOR EQUIPMENT AND METHOD OF USE,” the contents of which are hereby incorporated by reference in their entirety.

### TECHNICAL FIELD

The present technology pertains generally to enclosures and methods of using enclosures.

### BACKGROUND

Enclosures, such as bags, backpacks, and suitcases, can be used to transport various items. Enclosures can often be designed to carry a variety of different items within an internal volume, such as a pocket. The internal volume can typically be accessed through an opening on the enclosure, which can be opened and closed as desired. When opened, items can be placed within, or retrieved from, the internal volume as desired. When closed, the items within the internal volume can be loosely secured.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment of the present disclosure, an enclosure for equipment is described. The enclosure can include a body defining an outer surface and an interior. The body can have a longitudinal axis that extends between a first end of the body and a second end of the body opposite the first. The interior can include first, second, and third compartments that are disposed in series along the longitudinal axis. The first compartment can have a first cross-sectional area, the second compartment can have a second cross-sectional area, and the third compartment can have a third cross-sectional area. The second cross-sectional area can be larger than the first and third cross-sectional areas. The enclosure can also include an opening that extends across at least a portion of one of the first, second, and third compartments.

In another embodiment of the present disclosure, an enclosure for equipment is described. The enclosure can include a body defining an outer surface and an interior. The body can have a longitudinal axis that extends between a first end of the body and a second end of the body opposite the first end. The interior can include first, second, and third compartments that are disposed in series along the longitudinal axis. The first compartment can have a first length and a first cross-sectional area, the second compartment can have a second length and a second cross-sectional area, and the third compartment can have a third length and a third cross-sectional area. The second cross-sectional area can be larger than the first and third cross-sectional areas. The enclosure can also include an extension section that is disposed in either of the first or third compartment. The extension section can allow for variable first and/or third lengths.

In another embodiment of the present disclosure, an enclosure for equipment is described. The enclosure assembly can include a body defining an outer surface and an interior. The body can have a longitudinal axis that extends between a first end of the body and a second end of the body opposite the first end. The enclosure assembly can also include a support member that is coupled to the body. The support member can define a first side and a second side opposite the first side. The first side can include a first contour that can interface with a surface. The second side can include a second contour that can interface with the equipment. The second side can be oriented towards the interior of the body.

In another embodiment of the present disclosure, a method for using an enclosure assembly is described. The method can include preparing the enclosure assembly; storing equipment within the enclosure assembly; and adjusting the enclosure assembly. The enclosure assembly can include a body defining an outer surface and interior, with the body having a longitudinal axis extending between a first end of the body and a second end of the body opposite the first. The interior can include first, second, and third compartments disposed in series along the longitudinal axis. The first compartment can have a first cross-sectional area, the second compartment can have a second cross-sectional area, and the third compartment can have a third cross-sectional area. The second cross-sectional area can be larger than the first and third cross-sectional areas.

In another embodiment of the present disclosure, an enclosure for equipment is described. The enclosure can include a body defining an outer surface and an interior, the body having a longitudinal axis extending between a first end of the body and a second end of the body opposite the first end. The interior can include first, second, and third compartments disposed in series along the longitudinal axis. The first compartment can have a first cross-sectional area, the second compartment can have a second cross-sectional area, and the third compartment can have a third cross-sectional area, with the second cross-sectional area being larger than the first and third cross-sectional areas. The enclosure can also include an opening extending across at least a portion of one of the first, second, or third compartments.

In any of the embodiments described herein, the outer surface of the body can define a first side and a second side that each extend along the length of the longitudinal axis between the first and second ends.

In any of the embodiments described herein, the first side includes a first material and the second side includes a second material.

In any of the embodiments described herein, the first material is adjustable.

In any of the embodiments described herein, the first material can be neoprene and the second material can be nylon.

In any of the embodiments described herein, the first material and the second material can be the same.

In any of the embodiments described herein, the first side can be adjustable such that the first side is configured to conform to equipment disposed within the first, second, and third compartment.

In any of the embodiments described herein, the first side can define an outer portion and an inner portion, and the outer portion can be movable relative to the inner portion.

In any of the embodiments described herein, the outer portion can be formed from a first material and the inner portion can be formed from a second material.

In any of the embodiments described herein, the inner portion can include a weave.

In any of the embodiments described herein, the outer portion can extend along the length of at least a portion of the first, second, and third compartments.

In any of the embodiments described herein, the second compartment can be adjustable between a first configuration, where the second compartment is empty, and a second configuration, where equipment is stored within the second compartment. The second cross-sectional area can be larger in the second configuration than in the first configuration.

In any of the embodiments described herein, the second cross-sectional area can vary across the length of the second compartment.

In any of the embodiments described herein, the outer surface of the body can define a first planar surface extending along at least a portion of the length of the first compartment, and the planar surface can be configured to interface with a roof rack.

In any of the embodiments described herein, the outer surface of the body can define a second planar surface extending along at least a portion of the length of the third compartment, and the second planar surface can be configured to interface with the roof rack.

In any of the embodiments described herein, the first and third cross-sectional areas can be about the same.

In any of the embodiments described herein, the extension section can be disposed in both the first and third compartments.

In any of the embodiments described herein, the extension section can include a panel coupled to a first portion and a second portion of the body.

In any of the embodiments described herein, the first and second portions of the body can be configured to transition between a first position, where the first and second portions are removably coupled together, and a second position, where the panel extends between the first and second portions.

In any of the embodiments described herein, the first portion, second portion, and panel can enclose the first or third compartment when in the second position.

In any of the embodiments described herein, the panel can be elastic.

In any of the embodiments described herein, the interior can include first, second, and third compartments disposed in series along the longitudinal axis, and the support member can be disposed along the length of the second compartment.

In any of the embodiments described herein, the first compartment can have a first cross-sectional area, the second compartment can have a second cross-sectional area, and the third compartment can have a third cross-sectional area. The second cross-sectional area can be larger than the first and third cross-sectional areas.

In any of the embodiments described herein, the first planar surface can be spaced apart from the support member.

In any of the embodiments described herein, the support member can define a width, and the width extends across at least half of the width of the second compartment.

In any of the embodiments described herein, the second side of the support member can include a securing member for securing the equipment to the second side of the support member.

In any of the embodiments described herein, the enclosure can further include a strap assembly coupled to the first side of the support member, the strap assembly can be configured for coupling to the user.

In any of the embodiments described herein, the support member can be spaced apart from the first end of the body and the second end of the body.

In any of the embodiments described herein, the outer surface of the body can be disposed between the support member and the interior.

In any of the embodiments described herein, preparing the enclosure assembly can include opening the body of the enclosure assembly.

In any of the embodiments described herein, storing equipment within the interior of the enclosure assembly can include positioning the equipment within at least a portion of the first, second, and third compartments.

In any of the embodiments described herein, adjusting the enclosure assembly can include adjusting the length of the first compartment.

In any of the embodiments described herein, adjusting the enclosure assembly can include increasing the second cross-sectional area.

In any of the embodiments described herein, the method for using an enclosure assembly can further include positioning the enclosure assembly on a vehicle.

In any of the embodiments described herein, the first end of the body can be flared.

In any of the embodiments described herein, the enclosure can further include a reinforcing portion that is coupled to the first end of the body.

In any of the embodiments described herein, the reinforcing portion can be configured to increase the thickness of the body at the first end.

In any of the embodiments described herein, the reinforcing portion can surround the first end of the body.

In any of the embodiments described herein, the body can include ripstop nylon.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings depict example embodiments of the disclosure and are therefore not to be considered limiting of its scope.

FIG. 1 illustrates a side view of an enclosure assembly in accordance with one or more embodiments of the present disclosure.

FIG. 2 illustrates a side view of skis being placed within an enclosure assembly in accordance with one or more embodiments of the present disclosure.

FIG. 3A illustrates a side view of an enclosure assembly positioned on a roof rack of a vehicle in accordance with one or more embodiments of the present disclosure.

FIG. 3B illustrates a side view of an enclosure assembly being carried by a user in accordance with one or more embodiments of the present disclosure.

FIG. 3C illustrates a side view of an enclosure assembly being carried as a backpack by a user in accordance with one or more embodiments of the present disclosure.

FIG. 4A illustrates a top view of an enclosure assembly in accordance with one or more embodiments of the present disclosure.

FIG. 4B illustrates a top cross-sectional view of the enclosure assembly of FIG. 4A.

FIG. 5A illustrates a first side view of the enclosure assembly of FIG. 4A.

FIG. 5B illustrates a second side view of the enclosure assembly of FIG. 4A.

FIG. 6A illustrates a top view of the enclosure assembly of FIG. 4A in a first configuration.

FIG. 6B illustrates a top view of the enclosure assembly of FIG. 4A in a second configuration.

FIG. 7A illustrates a partial end view of the enclosure assembly of FIG. 4A.

FIG. 7B illustrates a partial end view of the enclosure assembly of FIG. 4A.

FIG. 8A illustrates a side view of the enclosure assembly of FIG. 4A with one or more extension sections in a second configuration.

FIG. 8B illustrates a side view of the enclosure assembly of FIG. 4A with one or more extension sections in a first configuration.

FIG. 9A illustrates a partial end view of the enclosure assembly of FIG. 8A.

FIG. 9B illustrates a partial top end view of the enclosure assembly of FIG. 8A.

FIG. 10A illustrates a bottom view of the enclosure assembly of FIG. 4A.

FIG. 10B illustrates a partial bottom view of the enclosure assembly of FIG. 10A.

FIG. 10C illustrates a partial top cross-sectional view of the enclosure assembly of FIG. 10A.

FIG. 11A illustrates a top view of an enclosure assembly in accordance with one or more embodiments of the present disclosure.

FIG. 11B illustrates a top cross-sectional view of the enclosure assembly of FIG. 11A.

FIG. 12 illustrates a side view of the enclosure assembly of FIG. 11A.

FIG. 13 illustrates a bottom view of the enclosure assembly of FIG. 11A FIG. 14A illustrates a closeup top view of a portion the enclosure assembly of FIG. 11A.

FIG. 14B illustrates a partial end view of the enclosure assembly of FIG. 11A.

FIG. 15 is a flow diagram illustrating an example method for using an enclosure assembly in accordance with one or more embodiments of the present disclosure.

### DETAILED DESCRIPTION

Winter sports equipment can be a hassle to transport between various locations. This hassle is especially true for skis, as it can be particularly challenging to carry skis. More specifically, skis are cumbersome, have no natural place to grip, and are generally awkward to move around. As a result, many skiers have a frustrating experience when attempting to carry skis by hand. To help aid with transporting skis, many skiers can rely on a vehicle (such as a personal vehicle, ski shuttle, etc.) to move skis between locations. However, even when relying on a vehicle, skiers can still face frustrations with transporting and maneuvering their skis. For instance, even when a skier relies on a vehicle, the skier still needs to handle their skis by hand, as the skier often must carry the skis to and from the vehicle and load and unload the skis. In some instances, such as when a skier uses a shuttle, the skiers may need to maintain control over the skis throughout the duration of their trip, which can also be a frustrating experience. For example, when a skier carries the skis onto a shuttle, the skier may need to keep a hold of their skis so as to ensure their skis do not fall onto other passengers or damage the skis or other equipment, which can be challenging due to the unwieldly and cumbersome nature of skis. Relying on a vehicle to carry skis can introduce other frustrations and challenges to transporting skis. As one example of this frustration, skis can be damaged when relying on a storage system of a vehicle. For instance, placing skis onto external storage for transporting (e.g., on a roof rack.), can potentially dirty the skis due to exposure to the outside environment (e.g., dirt, debris, road salts, etc.) and may even damage the skis. These and other factors can render transporting skis a hassle and a frustrating experience.

The present disclosure addresses these and other issues of transporting winter sports equipment, and, in particular, transporting skis. In some examples, the present disclosure describes an enclosure assembly which can be used to transport skis and other equipment. As will be described in more detail herein, this enclosure assembly includes several features that make transporting skis an easier experience for the skier. As one example, the enclosure assembly can include one or more interior compartments for receiving and storing equipment, such as skis. These interior compartments can be arranged so that the enclosure assembly provides a form-fit that closely surrounds the equipment. This form-fit design can (among other benefits) help make handling skis a much easier experience for the carrier. As another example, the enclosure assembly can easily interface with a vehicle, such as a roof rack or other storage system, and can protect the skis from damage. For instance, the enclosure assembly can define several planar surfaces along the perimeter of the enclosure assembly, which can allow for the enclosure assembly to easily interface with a storage rack on a vehicle. Once secured to the vehicle, the enclosure assembly can protect the skis from dirt, debris, and damage. As another example, the enclosure assembly can be arranged as a backpack-like device (or as a duffle bag) so that a skier can carry the skis without the hassle of having to carry the skis by hand. In some of these examples, the enclosure assembly can quickly and easily transition to a backpack, and so the carrier can use the enclosure assembly as a backpack, even if the enclosure assembly was secured to a vehicle shortly before. These and other benefits of the enclosure assembly will be described in further detail herein.

While the present disclosure references carrying equipment such as skis, those of ordinary skill in the art will appreciate that the present disclosure is not limited to carrying skis. For example, in some arrangements, the enclosure assembly of the present disclosure can be configured to carry other sports equipment, such as ski poles, a snowboard, snowshoes, etc., in addition to (or in lieu of) skis. In other arrangements, the enclosure assembly of the present disclosure can be configured to carry a cumbersome item. In various arrangements, the enclosure assembly of the present disclosure can be configured to carry an item that can be placed on a roof rack of a car (or a hitch rack, trunk of a car, truck bed, etc.). These and other examples are within the scope of the present disclosure. Additionally, while the present disclosure refers to carrying equipment, those of ordinary skill in the art will appreciate that the equipment may be handled in other manners. For instance, the skis may be carried, transported, maneuvered, etc., and so reference to one manner of handling equipment is not necessarily limiting to other manners of handling the equipment. Indeed, where appropriate from the context, these terms for handling may be used interchangeably without intending to limit the scope of the present disclosure.

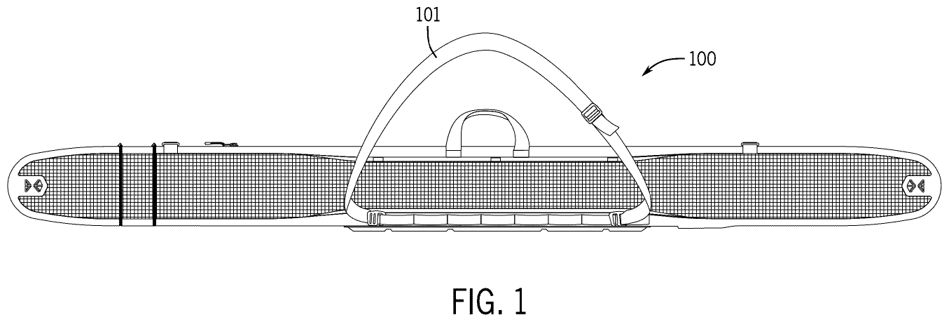

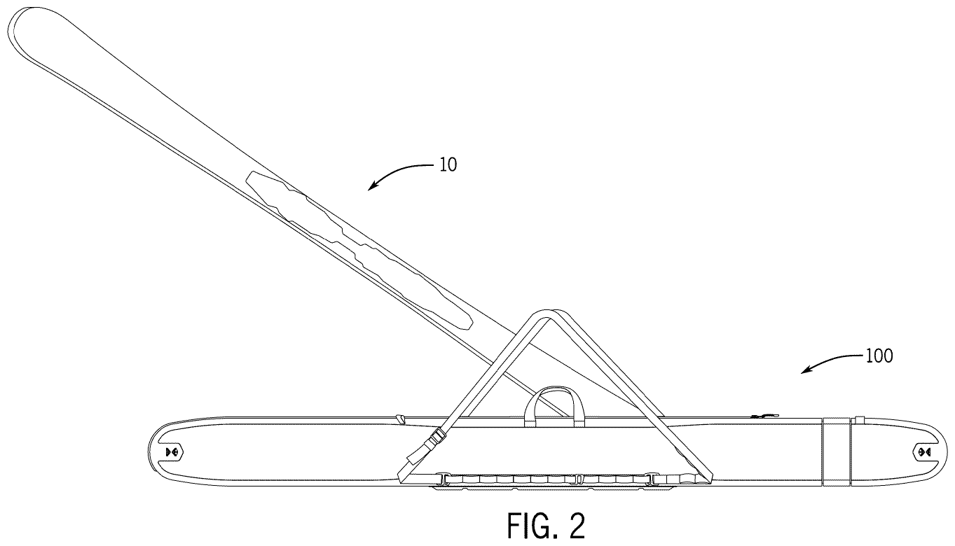

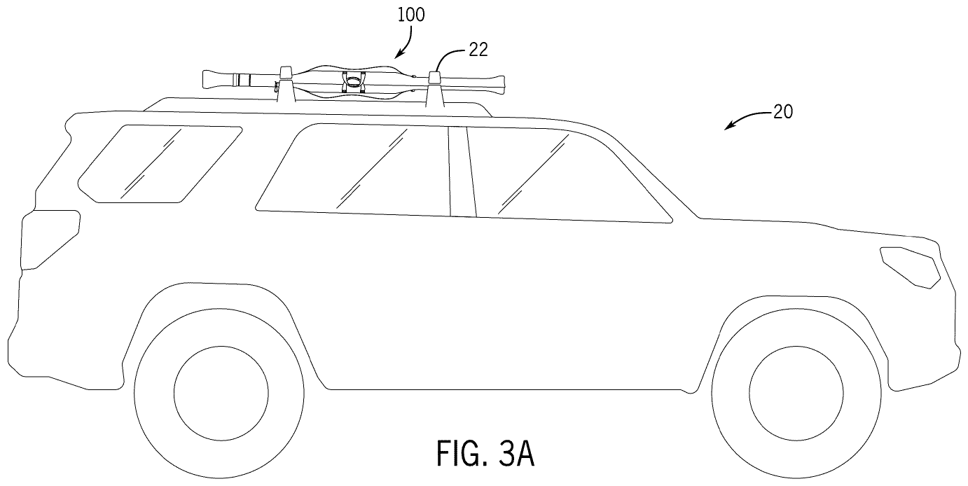

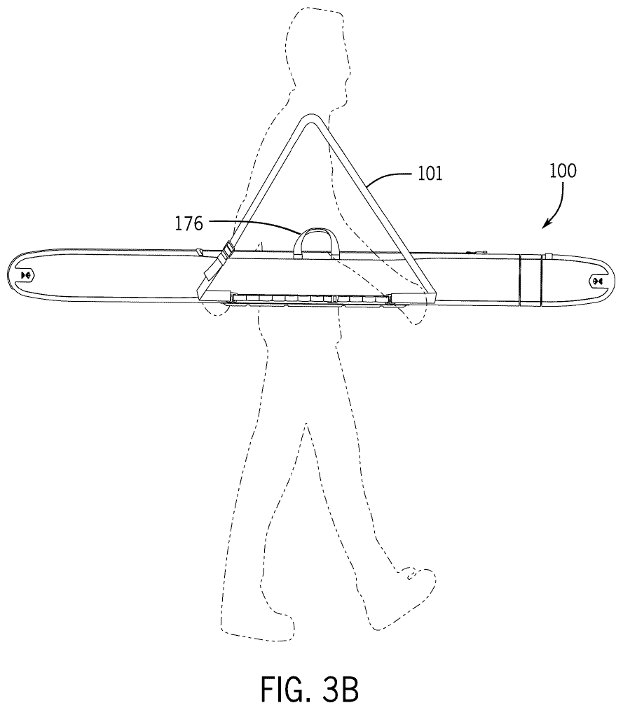

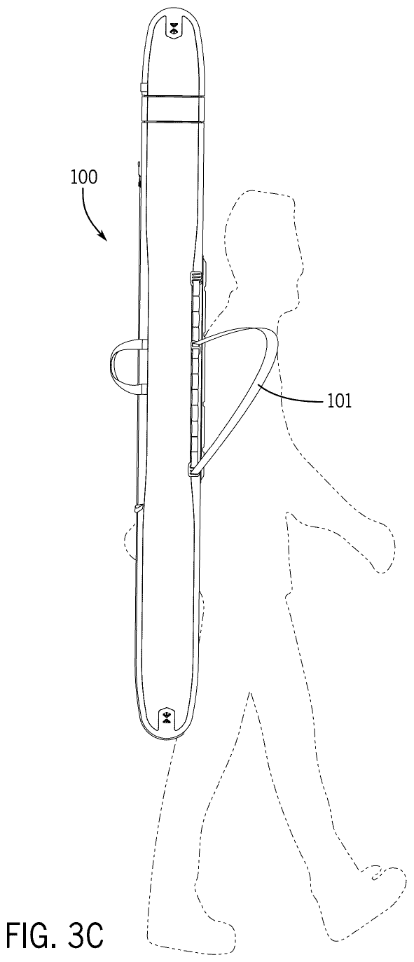

FIG. 1 illustrates an enclosure assembly 100. The enclosure assembly 100 can be configured to store equipment and other suitable items for transportation. For example, as shown in FIG. 2, the enclosure assembly 100 can be configured to store a pair of skis 10. The skis 10 (and other equipment) can be positioned and secured within the enclosure assembly 100 for storage. Once the skis 10 are stored within the enclosure assembly 100, the skis 10 can be transported to a desired location through a variety of different methods. For instance, as one example, the enclosure assembly 100 can be positioned on a roof rack 22 of a vehicle 20 as shown in FIG. 3A. Thus, as will be described in more detail herein, in some arrangements the enclosure assembly 100 can be configured to interface with a vehicle, such as the vehicle 20. As another example, the enclosure assembly 100 can be carried by a user, including in an over-the-shoulder fashion as shown in FIG. 3B and in a backpack-like fashion as shown in FIG. 3C, or by hand using the provided handles 176. In these and other examples, the enclosure assembly 100 can include a strap assembly 101 which can couple to the enclosure assembly and enable a user to carry the enclosure assembly in an over-the-shoulder fashion or as a backpack. In several examples, the enclosure assembly 100 can be configured so that the enclosure assembly 100 can both interface with a vehicle 20 and be carried by a user without needing to significantly adjust the enclosure assembly 100 or the equipment stored within.

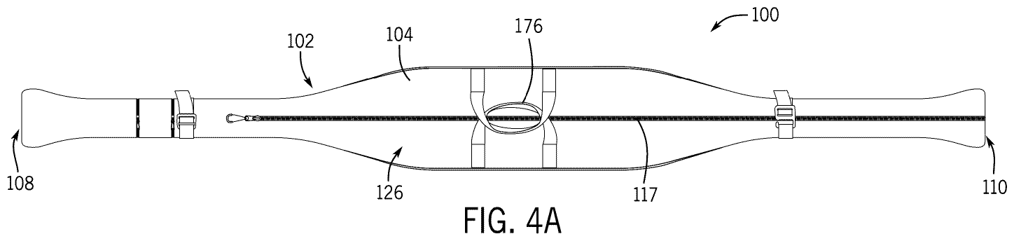

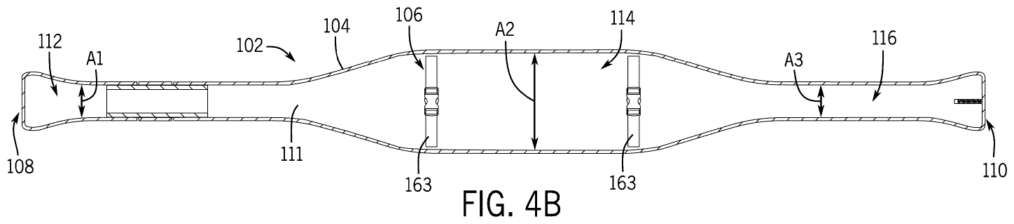

FIG. 4A illustrates a top view of the enclosure assembly 100, and FIG. 4B illustrates a top cross-sectional view of the enclosure assembly 100 of FIG. 4A. Referring to FIGS. 4A and 4B together, the enclosure assembly 100 can include a body 102 that defines an outer surface 104 and an interior 106. The interior 106 can be configured to receive an item within (such as the skis 10), while the outer surface 104 can enclose the interior 106 and provide suitable protection to the interior 106 and any equipment positioned within. The body 102 can be configured to have any suitable shape. For instance, as shown in FIGS. 4A and 4B, the body 102 has an elongated shape that extends along a longitudinal axis from a first end 108 to a second end 110 opposite the first end 108. In some examples, the body 102 can include an inner lining 111 coupled to the outer surface 104, with the inner lining 111 defining the interior 106. In other examples, however, the body 102 does not include an inner lining 111, and thus, the inner face of the body 102 can define the interior 106 while the outer face of the body 102 defines the outer surface 104.

In some arrangements, the interior 106 of the body 102 can include one or more compartments for storing an item. For instance, as shown in FIG. 4B, the body 102 can define first, second, and third compartments 112, 114, 116 that are positioned along the length of the body 102 and between the first and second ends 108, 110. As illustrated, the first, second, and third compartments 112, 114, 116 can be arranged in series. For instance, the first compartment 112 can extend from the first end 108 and to the second compartment 114, which can be positioned substantially centrally on the body 102, and the third compartment 116 can extend from the second compartment 114 and to the second end 110. In some examples, the first, second, and third compartments 112, 114, 116 can define a single internal volume that encompasses the entire interior 106. Thus, in some arrangements, the first, second, and third compartments 112, 114, 116 are not necessarily sealed off from one another. Each compartment 112, 114, 116 can have a specific cross-sectional area that can be different than (or similar to) a cross-sectional area of a separate compartment 112, 114, 116. For instance, as shown in FIG. 4B, the first compartment 112 can have a first cross-sectional area A1, which can be smaller than a second cross-sectional area A2 of the second compartment 114, but about substantially the same size as a third cross-section area A3 of the third compartment 116. By varying the cross-sectional areas of the first, second, and third compartments 112, 114, 116, the body 102 can be configured to better conform to specific objects disposed within the interior 106. For instance, the cross-sectional areas A1, A2, A3 can be adjusted so that the body 102 can conform to the skis 10 by arranging the first and third compartments 112, 116 to have a narrower cross-sectional area than the second compartment 114. In this arrangement, the narrower first and third compartments 112, 116 can conform to the shape of the nose and tail of the skis 10, while the wider second compartment 114 can conform to the bindings of the ski 10.

In some embodiments, the cross-sectional areas A1, A2, A3 can vary along the length of each compartment 112, 114, 116. For example, as illustrated in FIG. 4B, an end of the first and third compartment 112, 116 can be flared, and the width of the second compartment 114 can taper at its ends. By flaring the ends of the first and third compartments 112, 116, the first and third compartments 112, 116 can have a shape that more closely aligns with the ends of skis 10. Similarly, by having a wide second compartment 114 with tapered ends, the shape of the second compartment 114 can more closely align with the bindings of skis 10. In some embodiments, the maximum cross-sectional area of the second compartment 114 is greater than the maximum cross-sectional area of the first and third compartments 112, 116. In various embodiments, the cross-sectional areas of the first and third compartments 112, 116 can be about the same. In several arrangements, the ratio of the cross-sectional area of the second compartment to the cross-sectional area of first compartment 112 (and/or the third compartment) can be about 1.5 to 1, 2 to 1, 2.5 to 1, 3 to 1, 4 to 1, or 5 to 1. Arranging the first, second, and third compartments 112, 114, 116 in these (or other) manners can allow for the interior 106 to conform to the shape of skis 10 and thereby provide a tight and secure fit to the skis 10 once placed within the interior 106 Still referring to FIGS. 4A and 4B, the body 102 can include a closing device 117, which can adjustably open or close the interior 106 as desired. In the illustrated embodiment, the closing device 117 is shown as a zipper that is coupled to the outer surface 104. However, in other embodiments, the closing device 117 can include a separate device (in addition to or in lieu of the zipper) for opening and closing the interior 106. For instance, in some arrangements, the closing device 117 can include several straps and buckles positioned along the length of the body 102. As shown in FIGS. 4A and 4B, the closing device 117 can extend across a portion of the outer surface 104 of the body 102 and can provide access to the interior 106 by forming an opening along the outer surface 104. In some arrangements, the closing device 117 can extend across at least a portion of the first, second, and third compartments 112, 114, 116. Thus, in some arrangements, the closing device 117 can form an opening in the body 102 that extends across at least a portion of one of the first, second, and third compartments 112, 114, 116.

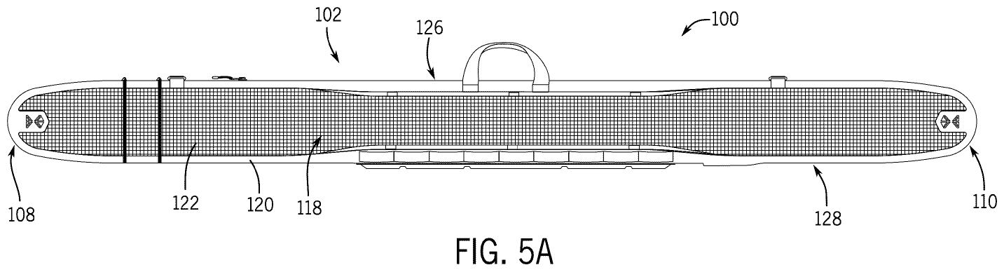

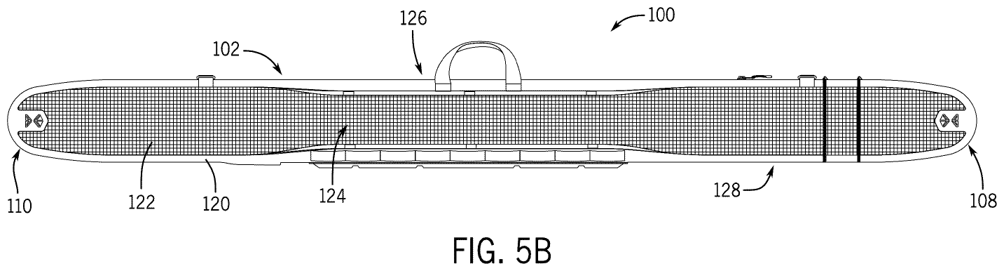

As previously indicated, the body 102 can conform to an item (such as skis 10) that is disposed within the interior 106 by varying the general shape (e.g., the cross-sectional areas A1, A2, A3) of the body 102 along its length. In addition to (or in alternative of) varying the general shape, the body 102 can conform to an item disposed within the interior by being adjustable. FIGS. 5A and 5B, which show side views of an enclosure assembly 100, illustrate at least one example of this adjustability. As shown in FIG. 5A, the body 102 defines a first side 118 that can extend along the longitudinal axis of the body 102 from (or about) the first end 108 to (or about) the second end 110. This first side 118 can define a first outer portion 120 that extends around the perimeter of the first side 118 and a second inner portion 122 that is disposed inward of the outer portion 120. The outer and inner portions 120, 122 can be formed from different materials, which can improve the adjustability of the first side 118. For instance, the outer portion 120 can be formed from a first, adjustable (e.g., flexible, expandable, stretchable, constricting, etc.) material while the inner portion 122 can be formed from a second, reinforcing, structural, or rigid material. Configuring the outer and inner portions 120, 122 in this manner can allow for the outer portion 120 to flex when an item within the interior 106 presses against the inner portion 122. This arrangement can allow for the first side 118 to expand and thereby conform to the item within the interior 106. Additionally, the reinforcing material forming the inner portion 122 can be configured to prevent (or limit) the inner portion 122 from being damaged as the skis 10 (or other item) press into the inner portion 122.

In some embodiments, the first material can be rubber, or a rubber like material, such as neoprene or may be a synthetic material, such as nylon. In some of these arrangements, or otherwise, the first material can be a more flexible, more adjustable, and less rigid than the second material or can include excess material (e.g., to create slack), which can improve the expandability of the first material. In some examples, the second material can be a synthetic material like nylon or a similar material. Additionally, the second material can be arranged as a weave (e.g., interlacing threads, intersecting threads etc.), and/or can provide additional reinforcement to the portion utilizing the second material. For instance, the second material can be arranged as a mesh or as a ripstop. In some arrangements, the first material can be used to form the inner portion 122 while the second material can be used to form the outer portion 120. In various arrangements, the same material (e.g., the first or second material) can form both the outer and inner portions 120, 122. Thus, in some examples, the first side 118 can be formed from a single material. In some of these examples, the first side 118 can be formed primarily from, or entirely of, ripstop nylon.

Other portions of body 102 beyond the first side 118 can be configured as adjustable. For instance, referring to FIG. 5B, the body 102 can define a second side 124 opposite the first side 118, which can be arranged in a similar manner to the first side 118. For example, the second side 124 can include the outer portion 120 and the inner portion 122, with the outer and inner portions 120, 122 being formed from the same materials as the outer and inner portions 120, 122 of the first side 118. In this arrangement, the outer portion 120 of the second side 124 can flex to help the body 102 conform to an item within the interior 106.

As shown in FIGS. 5A and 5B, the outer portion 120 of both the first and second sides 118, 124 can extend along the longitudinal axis of the body 102 and along the length of at least a portion of the first, second, and third compartments 112, 114, 116. Configuring the outer portion 120 of both the first and second sides 118, 124 in this manner can allow for the outer portion 120 of both the first and second sides 118, 124 to expand or contract as needed and at various points across the length of the outer portions 120. Thus, in some arrangements, the outer portion 120 may expand across a particular length of the body 102 but may remain otherwise unexpanded (e.g., relaxed, unstretched, neutral, etc.) across other lengths of the body 102. For example, the outer portion 120 can expand across the length of the second compartment 114 but can remain relatively unexpanded across the first and third compartments 112, 114.

While the outer portion 120 of both the first and second sides 118, 124 can allow for the body 102 to adjust along its width as needed, the inner portion 122 of both the first and second sides 118,124 can reinforce at least a portion of the body 102. As shown in FIGS. 5A and 5B, the inner portion 122 of both the first and second sides 118, 124 can extend along the longitudinal axis of the body 102 and along at least a portion of the first, second, and third compartments 112, 114, 116. Configuring the inner portion 122 in this manner can provide support to the body 102 along the inner portion 122. Thus, in some arrangements, the inner portion 122 can reinforce portions of body 102 and prevent the body 102 from damage (e.g., ripping, tearing, etc.) due to placing items within the interior 106.

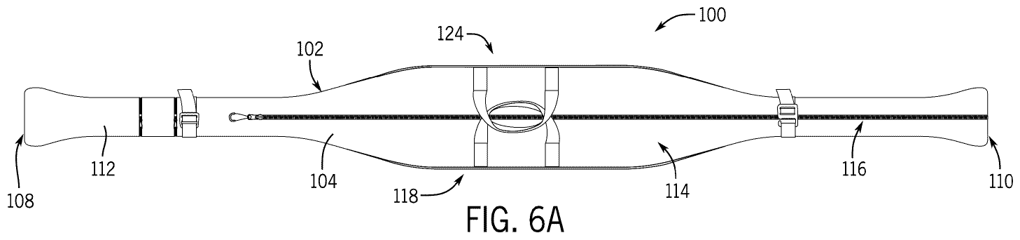

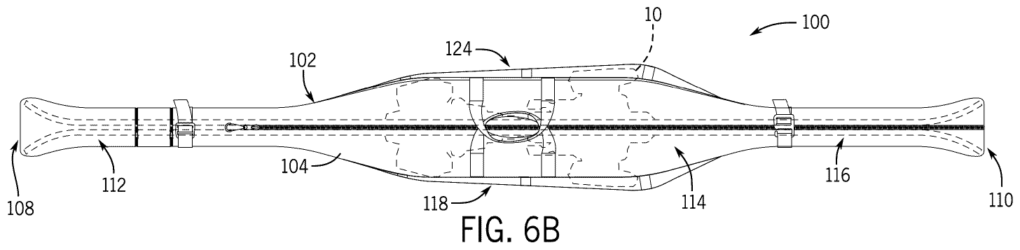

FIGS. 6A and 6B illustrate the body 102 adjusting (e.g., expanding, stretching, conforming, form-fitting, etc.) to a pair of skis 10 placed within the interior 106 of the body 102. FIG. 6A illustrates the body 102 with the interior 106 empty, and as shown in FIG. 6A, the first and second sides 118, 124 of the body 102 are in a neutral position (e.g., unexpanded, unstretched, etc.). When the skis 10 are placed within the interior 106 as shown in FIG. 6B, portions of the first and second sides 118, 124 of the body 102 can expand to conform to the skis 10. For instance, the first and second sides 118, 124 surrounding the second compartment 114 can expand (e.g., flex, stretch, bow, etc.) outwards to accommodate the bindings of the skis 10. In some of these arrangements, the flexibility or adjustability of the first material (e.g., the material forming the outer portion 120) can allow for the first and second sides 118, 124 to conform to the shape of the skis 10 within the interior 106 as shown. Furthermore, in some of these arrangements, the inner portion 122 can reinforce the body 102 to prevent the body 102 from tearing due to the skis 10 within the interior 106. Thus, the body 102 can form a tight, secure fit with the skis 10, as the first material can flex to accommodate the width of the skis 10 within while the second material can reinforce the body 102 as the skis 10 press against the body 102.

The adjustability of the body 102 can be viewed as the body 102 being configured to transition between two or more configurations. For instance, as one example, the body 102 can transition between a first configuration, where the interior 106 is empty (e.g., as shown in FIG. 6A), and a second configuration, where an item is disposed within the interior 106 (e.g., as shown in FIG. 6B). In the first configuration, the body 102 can be in a natural, unexpanded, and unflexed state, as there is no item within the interior 106 to push against the body 102. In the second configuration, the body 102 can be in an expanded or flexed state, as there is an item pressing against the body 102 from within interior 106. In some of these arrangements, the cross-sectional areas of the first, second, and third compartments 112, 114, 116 can vary between the first and second configurations. For instance, the cross-sectional area A2 of the second compartment can be smaller in the first configuration than in the second configuration. In some instances, only the cross-sectional area A2 varies between the first and second configurations, while in other instances, only the cross-sectional area A1 and/or cross-sectional area A3 vary between the first and second configurations. In some examples, all three cross-sectional areas A1, A2, A3 vary between the first and second configurations. In some arrangements, the body 102 can be biased to transition from the second configuration to the first configuration (e.g., the body 102 is configured to transition to its unstretched state). By arranging the body 102 in this manner, the body 102 can be configured to tighten around skis 10 disposed within the interior 106 more securely. Additionally, once the skis 10 are removed from the interior 106, the body 102 can naturally revert to the first configuration.

In some arrangements, portions of the body 102 can conform to the skis 10 without necessarily needing to adjust (e.g., flex, stretch, expand, etc.) around a portion of the skis 10. For instance, as shown in FIGS. 6A and 6B, the first and third compartments 112, 116 can maintain substantially the same cross-sectional area with or without the skis 10 being disposed within the interior 106, as the outer surface 104 surrounding the first and third compartments 112, 116 remains unflexed. Despite these portions of the outer surface 104 remaining unflexed, the body 102 can still substantially conform to the shape of skis 10 disposed within the interior 106, as the narrower first and third compartments 112, 116 and the wider second compartment 114 can generally imitate the shape of the skis 10. In some examples, the enclosure assembly 100 can be configured so that the body 102 flexes minimally, if at all, when skis 10 are positioned within the interior 106. Thus, in some arrangement, the body 102 can be sized so that the body 102 surrounds the skis 10 without the first and second sides 118, 124 bowing outwards.

By arranging for the first and second sides 118, 124 (and/or other portions of the body 102) to be adjustable, the enclosure assembly 100 can be used to accommodate a variety of skis 10. Skis 10 can come in a variety of different shapes and sizes, and thus, designing an enclosure assembly 100 to accommodate skis 10 of different shapes and sizes can be challenging. However, by configuring the body 102 to be adjustable, a single enclosure assembly 100 can reliably secure skis 10 of varying shapes and sizes through adjusting as needed. In other arrangements, the size of body 102 can be made to any desired length and width so that the body 102 can reliably secure skis 10 of a particular size without needing the added adjustability.

Some portions of the body 102 can be configured to provide a suitable structure to the body 102 so that the body 102 can maintain its general shape. Referring again to FIGS. 4A and 5A, the body 102 can define a third side 126 along the top portion of the body 102 and a fourth side 128 along the bottom portion of the body 102. The third and fourth sides 126, 128 can be formed from a specific material (or materials) that allow for the third and fourth sides 126, 128 to provide some structure to the body 102, including, for instance, a more rigid material. Arranging the third and fourth sides 126, 128 in this manner can allow for the body 102 to maintain its general shape while still allowing for the first and second sides 118, 124 to be adjustable as needed. In some examples, the third and fourth sides 126, 128 can be formed from the same material as the outer portion 120 of the first and second sides 118, 124. Additionally, in some arrangements, the third and fourth sides 126, 128 can be uniformly formed with the outer portion 120 of the first and second sides 118, 124. Thus, in some of these examples, the third and fourth sides 126, 128 can help the body 102 expand to accommodate the size of skis 10 that are disposed within the interior 106 (e.g., by allowing for the first and second sides 118, 124 to flex as needed).

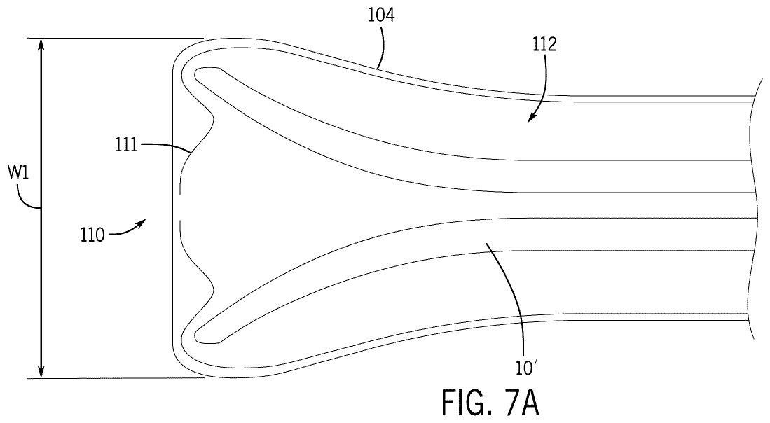

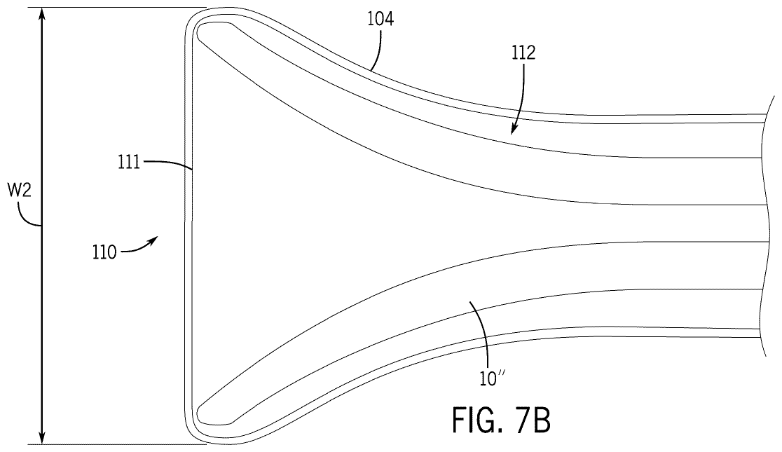

In some examples, other portions of the body 102 can be adjustable to conform to the shape of the skis 10 (or other item). For example, as shown in FIGS. 7A and 7B, the first compartment 112 of the interior 106 can also be adjustable to accommodate a portion of skis 10 (e.g., the tips or tails of skis 10). FIG. 7A illustrates a pair of skis 10′ disposed within the first compartment 112 and FIG. 7B illustrates a separate pair of skis 10″ also disposed within the same first compartment 112. As previously discussed, the size and shape of skis can vary greatly from ski to ski. As one example of this variety, the tips of skis 10′ from FIG. 7A have a smaller pitch than the skis 10″ from FIG. 7B, and thus, when disposed within the interior 106, the skis 10″ are wider than the skis 10′. To accommodate these different ranges of widths, the first compartment 112 can have an adjustable width. For instance, as shown in FIG. 7A, the first compartment 122 can be adjusted to have a width of W1, whereas in FIG. 7B, the same first compartment 112 can be adjusted to have a width of W2, with the width W2 being greater than W1. In some of these examples, the first compartment 112 can be adjustable through including additional (or excess) material. For instance, the inner lining 111 within first compartment 112 can include an additional amount of material at the end of the first compartment 112. When not all of this material is needed, the material can bunch up, as shown in FIG. 7A. When the first compartment 112 needs to expand, however, the inner lining 111 can stretch due to the additional material, which results in the first compartment 112 expanding to accommodate the increased size of the skis 10. In some of these instances, or otherwise, the inner lining 111 can work in tandem with the outer surface 104 to expand the size of the first compartment 112 as needed (e.g., the outer surface 104 can stretch as the inner lining 111 expands).

While the illustrated embodiment of FIGS. 7A and 7B shows the first compartment 112 as being adjustable, those of ordinary skill in the art will appreciate that the enclosure assembly 100 can be configured in other manners. As one example, other portions of the body 102 can be adjustable like the first compartment 112. For instance, the inner lining 111 within the second and third compartments 114, 116 can include additional material that allows for the second and third compartments 114, 116 to expand as needed. In other examples, the body 102 does not include an expandable inner lining 111, and instead, relies upon the expandability of the material forming the outer surface 104 (e.g., the first and second material) to accommodate skis 10 of a variety of sizes. In some examples, the body 102 can be reinforced at the ends 108, 110 of the body 102 to prevent the tips of skis 10 from damaging the body 102 (e.g., due to tearing or ripping the body 102). For instance, the body 102 can include additional material at the ends 108, 110 of the body 102 (e.g., padding) to protect against damage. This reinforcement can be in addition to, or in lieu of, the adjustability of the ends 108, 110. Thus, the material forming the ends of the body 102 can be thicker than the material at other portions of the body 102 (e.g., between the ends 108, 110 of the body 102). These and other arrangements of the enclosure assembly 100 are within the scope of the present disclosure.

By arranging the body 102 to conform to the shape of skis 10 (or other item) disposed within the interior 106, the enclosure assembly 100 can beneficially improve the user's experience with handling skis 10. As one example, by imitating the profile of the skis 10, the body 102 can use less material and have a smaller overall size, which makes maneuvering the enclosure assembly 100 an easier task. As another example, when the body 102 stretches around the skis 10 disposed within the interior 106, the skis 10 can be held in position within the interior 106 by the body 102 and can be limited from jostling (or otherwise moving) during use of the enclosure assembly 100. This arrangement can make handling of the enclosure assembly 100 an easier experience regardless of the size of the skis 10. In some examples, the conformity of the body 102 can prevent the skis 10 from unlinking while disposed within the interior 106. For instance, the form-fit nature of the body 102 can put sufficient pressure onto the skis 10 within the interior 106 so that the skis 10 can remain linked together, regardless of whether the enclosure assembly 100 is in motion (e.g., positioned on a moving vehicle, being carried by a skier, etc.) or stationary (e.g., in storage). This arrangement of the body 102 can help prevent the skis 10 from being damaged, as the skis 10 are limited from colliding with each other while stored within the interior 106. As an additional measure of secureness, however, in some of these arrangements, the skis 10 can be further secured within the interior 106 through a fastening mechanism (e.g., a strap, tie-down, etc.), which can further limit the skis 10 from moving within the interior 106. For instance, as shown in FIG. 4B, the interior 106 can include one or straps 163, which can be used to further secures the skis 10 within the interior 106.

In addition to conforming to the skis 10, in some embodiments, the body 102 can provide desirable protection to the skis 10 stored within the interior 106. As one example, the body 102 can be configured to have a suitable thickness so that the body 102 can provide padding to the skis 10 at various points along the body 102 (e.g., additional padding around the tips of the skis 10, around the bindings, etc.). As another example, the body 102 can shield the interior 106 from dirt, debris, and, in some instances, harmful chemicals. For instance, because the body 102 can enclose the interior 106 entirely, the body 102 can shield harmful chemicals (e.g., road salts) from the interior, and thus the body 102 can protect the skis 10 within. While the body 102 can shield the interior 106 entirely, in some arrangements, the body 102 may also have some breathability, which can allow for the body 102 to dry out from exposure to snow/water within the interior 106.

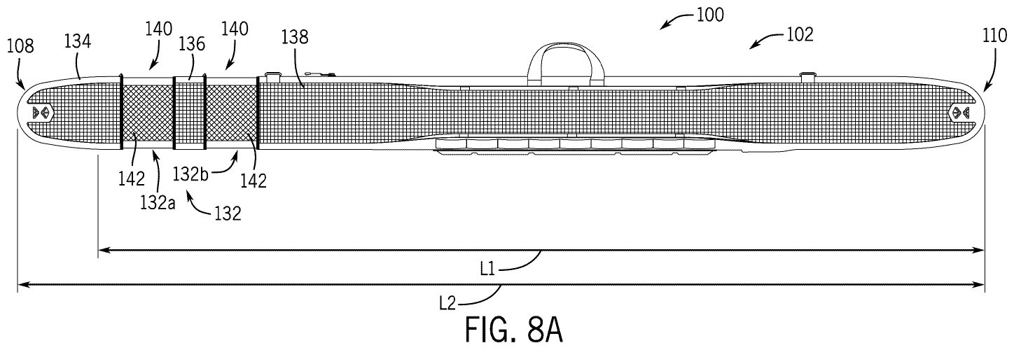

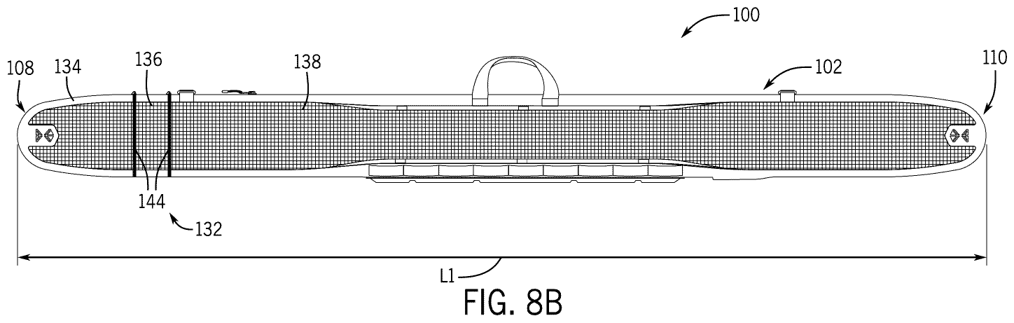

In some embodiments, the enclosure assembly 100 can be adjustable along its length. As previously described, skis 10 can come in a variety of shapes and sizes, including a variety of lengths, with many skis 10 being somewhere between about 4 feet to about 7 feet in length. Thus, to form-fit skis 10 of varying lengths, the enclosure assembly 100 can be adjusted along its length, including, in some instances, between a length of about 4 feet to about 7 feet. FIGS. 8A and 8B illustrate the enclosure assembly 100 with two extension sections 132, which can be configured to adjust the length of the body 102 when desired. The extension sections 132 (individually referred to as extension section 132a, 132b) can be coupled to the body 102 at any desired location along the longitudinal axis of the body 102. For instance, as shown in FIG. 8A, the extension sections 132 can be coupled to the body 102 near the first end 108, with the extension sections 132 being positioned adjacent to one another. While the illustrated embodiments show the enclosure assembly 100 as including two extension sections 132, the enclosure assembly 100 can be configured to include any desired number of extension sections 132, with each extension section 132 being spaced from one another in any desired manner. For instance, in some examples, the enclosure assembly 100 can include a third extension section 132 positioned near the second end 110 of the body 102 and a fourth extension section 132 positioned along the second compartment 114. In some examples, the enclosure assembly 100 may exclude the extension sections 132. In some of these examples, the enclosure assembly 100 can be made to securely fit skis 10 of a particular length without necessarily needing the added adjustability that the extension sections 132 can provide. For instance, the body 102 can be made to a length of 5 feet in order to fit skis 10 having a length of 5 feet without needing to adjust the body 102 along its length.

In some arrangements, the extension sections 132 can extend (or shorten) the length of the body 102 by allowing portions of the body 102 to move relative to one another along the longitudinal axis of the body 102. For instance, as shown in FIG. 8A, the body 102 can define a first portion 134, a second portion 136, and a third portion 138, which can each move relative to one another. In some of these arrangements, the extension sections 132 can extend between two (or more) of the first, second, and third portions 134, 136, 138 of the body 102, with each extension section 132 being configured to transition between a first, stowed configuration and a second, extended configuration. Transitioning the extension sections 132 from the stowed configuration to the extended configuration can increase the length of the body 102 by increasing the distance between the first, second, and/or third portions 134, 136, 138 of the body 102. As one example, each extension section 132 can incrementally increase the length of the body 102 within a particular range, such as between 0 inches to about 36 inches, 0 inches to about 24 inches, 0 inches to about 18 inches, 0 inches to about 12 inches, 0 inches to about 6 inches, or some other desired range. Thus, the extension sections 132 can extend (or shorten) the length of the body 102 to a particular length or lengths when desired.

FIGS. 8A and 8B illustrate the body 102 with the extension sections 132 in either the first, stowed configuration (as shown in FIG. 8B) or the second, extended configuration (as shown in FIG. 8A). When in the first, stowed configuration as shown FIG. 8B, the first and third portions 134, 138 are both directly coupled to the second portion 136. In this arrangement, the extension sections 132 are hidden from view from outside of the body 102 and do not space the first, second, and third portions 134, 136, 138 of the body 102 apart from each other. This arrangement also results in the body 102 having a length of L1, as each extension section 132 does not contribute to the overall length L1 of the body 102. When both extension sections 132 are in the second, expanded configuration as shown in FIG. 8A, the first and third portions 134, 138 are uncoupled from the second portion 136 and are spaced apart from the second portion 136 by the length of each extension section 132. This arrangement can increase the length of the body 102 from L1 to L2, as the extension sections 132 increase the distance between the first, second, and third portions 134, 136, 138 of the body 102. In some examples, the distance between L1 and L2 can be about 6 inches, 12 inches, 18 inches, 24 inches, 30 inches, 36 inches, or some other distance.

In some examples, each extension section 132 can be adjusted between the first and second configurations independently of the other extension sections 132. For instance, the extension section 132a can be arranged in the first configuration while the extension section 132b can be arranged in the second configuration. Configuring the extension sections 132 in this manner can allow for the body 102 to accommodate a particular length of skis 10 more precisely, as the overall length of the body 102 can be increased by the length of a single extension section 132 as opposed to increasing the length by two (or more) extension sections 132.

In some examples, the enclosure assembly 100 can be arranged in different sizes such that the enclosure assembly 100 can be suited for skis 10 of a particular length. For instance, in some examples, the enclosure assembly 100 can be configured for youth skis by being adjustable between a length of about 2.5 feet to about 4 feet. In another example, the enclosure assembly 100 can be configured for smaller skis by being adjustable between a length of about 4 feet to about 5.5 feet. In another example, the enclosure assembly 100 can be configured for larger skis by being adjustable between a length of about 5.5 feet to about 7 feet. Other arrangements of the enclosure assembly 100 may be possible, including an enclosure assembly 100 having a different length (e.g., 2.5 feet, 3 feet, 4 feet, 5.5 feet, 6 feet, etc.) and range of lengths (e.g., 2.5 to 4 feet, 3 feet to 4 feet, 4 feet to 7 feet, etc.) than explicitly specified.

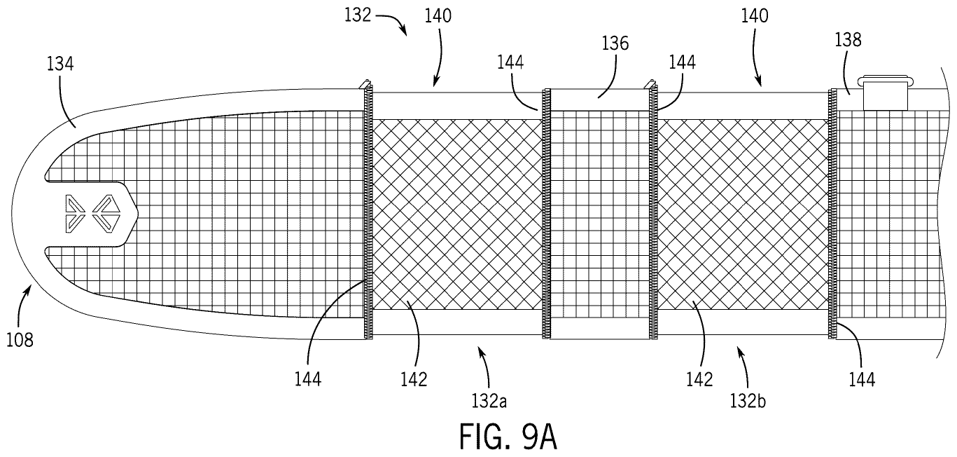

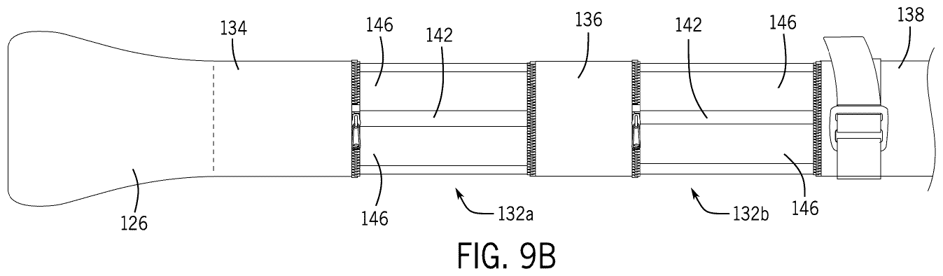

Additional details of the extension sections 132 will now be provided. FIGS. 9A and 9B illustrate closeup side and top views, respectively, of the extension sections 132. Referring to FIGS. 9A and 9B together, when the extension sections 132 are in the second configuration, each extension section 132 can define an opening 140 that extends between the first and second portions 134, 136 (for the extension section 132a) and the second and third portions 136, 138 (for the extension section 132b). Each extension section 132 can include a panel 142 that extends across the openings 140. The panel 142 can be configured to enclose the interior 106 when the extension section 132 is exposed (e.g., when the extension section 132 is in the second configuration). Thus, when the panel 142 is exposed, the panel 142 can define a portion of the outer surface 104 of the body 102. Additionally, when exposed, the panel 142 can define portions of the first, second, third, and fourth sides 118, 124, 126, 128. To close the opening 140, the first, second, and third portions 134, 136, 138 can each include at least one coupling member 144. The coupling members 144 can be configured to interface with one another to thereby close the opening 140 by coupling the first and second portions 134, 136 together and/or the second and third portions 136, 138 together. In the illustrated example, the coupling members 144 are adjustable zippers, however, other fasteners can be used to open and close the openings 140.

In some examples, each panel 142 can be coupled to a portion of the body 102. For example, the panel 142 of the extension section 132a can be coupled to the first and second portions 134, 136 of the body 102 and the panel 142 of the extension section 132b can be coupled to the second and third portions 136, 138 of the body 102. In some arrangements, the panels 142 can be coupled to the first, second, and third portions 134, 136, 138 of the body 102 so that these portions of the body 102 (and/or the panel 142) are movable relative to one another. As one example of this arrangement, the panel 142 can be configured as a sleeve or insert that is disposed within the interior 106 and extends across the openings 140 of both extension sections 132. Thus, in some arrangements, the extension sections 132 can be disposed within a particular compartment (e.g., the first, second, and/or third compartment 112, 114, 116). By arranging the panel 142 as a sleeve or insert, the first, second, and/or third portions 134, 136, 138 of the body 102 can be slidably adjustable relative to the panel 142 (e.g., in a telescoping manner), which can allow for a user to adjust the length of the body 102 as needed. Accordingly, in some examples, the extension sections 132 can allow for the first, second, and/or third compartment 112, 114, 116 to have a variable length. As another example of the movable arrangement, the panel 142 can be arranged in a folded (or pleated, rolled up, furled, bunched up, etc.) manner. For instance, the ends of the panel 142 can be coupled to the first, second, and/or third portions 134, 136, 138, and, when the extension section 132 is in the first configuration, the panel 142 can be folded within the interior 106. From this arrangement, the panel 142 can unfold and expand to transition the extension section 132 into the second configuration.

The extension sections 132 can be configured to keep the interior 106 enclosed (e.g., not exposed to an outside environment) when the extension sections 132 are in either the first or second configuration. When in the first configuration, the extension sections 132 can be positioned inward of the outer surface 104 of the body 102 and can be hidden from view from the outside. Thus, in this arrangement, the outer surface 104 of the body 102, including the first, second, and third portions 134, 136, 138, can completely enclose the interior 106. When in the second configuration, the panels 142 of each extension section 132 can extend between the first, second, and/or third portions 134, 136, 138 to enclose the opening 140 formed by the extension sections 132. The panels 142 (and/or other portions of the extension sections 132) together with the first, second, and third portions 134, 136, 138 can completely enclose the interior 106 when the extension section 132 is in the second configuration. Thus, in some examples, the extension sections 132 can form a portion of the outer surface 104 of the body 102.

In several arrangements, the panel 142 can be adjustable to accommodate an item disposed within the interior 106. For instance, similar to the outer portion 120 of the first and second sides 118, 124, the panel 142 can be formed from an adjustable material so that the panel 142 can flex to accommodate an item within the interior 106 as needed. Thus, in some instances, the panel 142 can work in tandem with the remaining portions of the first and second sides 118, 124 to accommodate an item within the interior 106. In some arrangements, the panel 142 can include additional padding to prevent tearing or damage to the panel 142. In one example, the panel 142 can be formed from an elastic material. Additionally, or alternatively, the panel 142 can be arranged as a weave. In some examples, the panel 142 can be configured as a mesh, including, for instance, a polyester mesh.

In some embodiments, the extension sections 132 can be biased to transition to the first configuration from the second configuration. For example, as shown in FIG. 9B, the extension sections 132 can include one or more biasing members 146, which can be arranged to bias the extension sections 132 into the first configuration after the extension sections 132 are deployed. In some arrangements, the biasing members 146 can be an elastic band (or flat elastic) that couples to, and extends between, the first and second portions 134, 136, the second and third portions 136, 138, and/or the first and third portions 134, 138. In these arrangements, the elastic band can be arranged so that it stretches once the extension section 132 begins to deploy. Thus, as a result of this stretching, the biasing members 146 (e.g., the elastic band) can act to pull the first, second, and/or third portions 134, 136, 138 together. In other arrangements, the biasing member 146 can be another suitable biasing member, such as, for instance, a spring,

As shown in FIG. 9B, the biasing member 146 can be positioned outward of the panel 142 and can be positioned substantially along the third and fourth sides 126, 128 of the body 102. However, the biasing member 146 can be configured in other arrangements. For instance, the biasing member 146 can be integrated with the panel 142 to thereby form a portion of the panel 142. As another example, the biasing member 146 can be positioned inward of the panel 142 so that the biasing member 146 is not exposed when the extension section 142 is in the second configuration. As another example, a biasing member 146 can extend along a portion of the first and/or second sides 118, 124 in addition to (or in lieu of) the third and fourth sides 126, 128. These and other arrangements of the biasing members 142 are within the scope of the present disclosure.

By including biasing members 146 (or otherwise biasing the extension section 132), the extension sections 132 can be configured to form a secure fit with the skis 10 (or other item) within the interior 106. This secure fit can be due to the body 102 being biased to constrict lengthwise, and thus, the body 102 can press against the ends of the skis 10 while the skis 10 are within the interior 106. As a result of this arrangement, the skis 10 can be more reliably secured along the length of the skis 10, which can further improve the handling of the enclosure assembly 100 and further limit the skis 10 from moving while positioned within the interior 106.

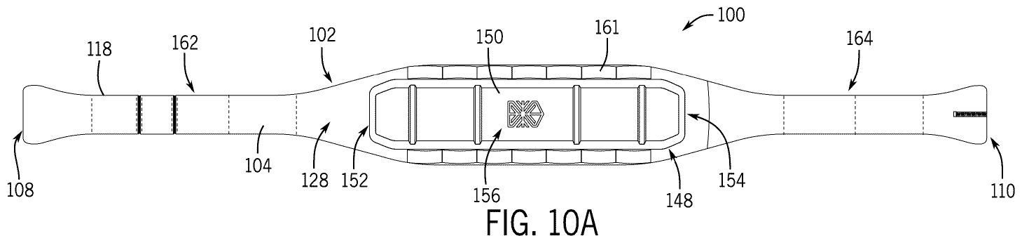

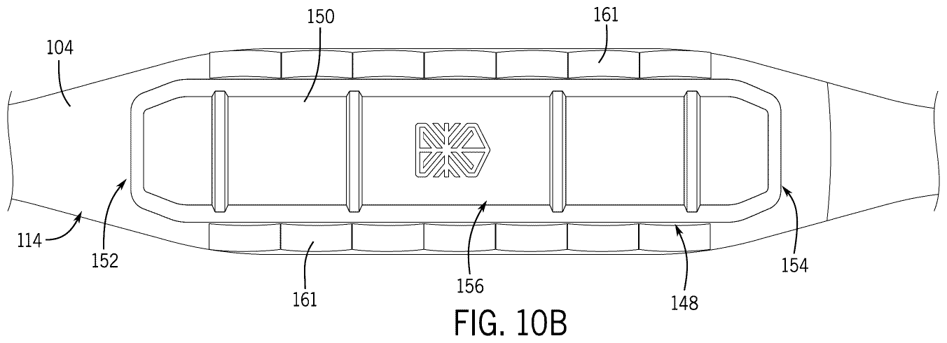

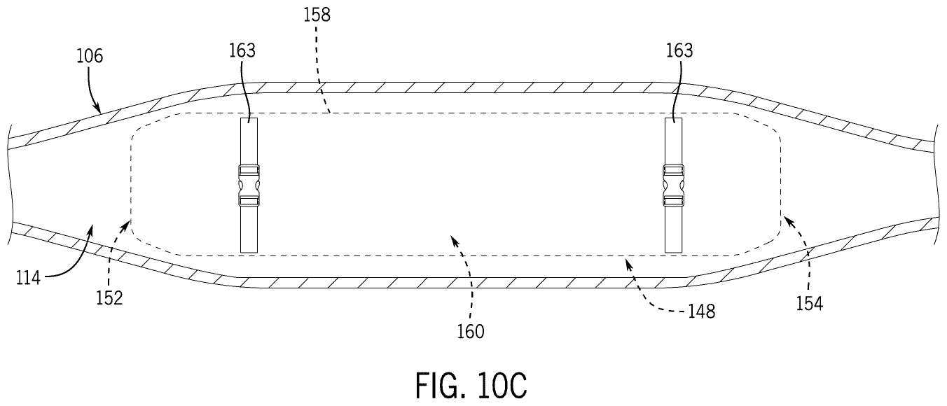

As previously described with respect to FIG. 3A-3C, the enclosure assembly 100 can be configured to interface with users and vehicles (e.g., the vehicle 20) for transporting the enclosure assembly 100 between various locations. In some instances, the enclosure assembly 100 can include one or more features that improve the ability of the enclosure assembly 100 to interface with users, racks, vehicles, or other items. For example, as shown in FIG. 10A-10C, the enclosure assembly 100 can include a support member 148 that can directly interface with both a user and a rack (e.g., a roof rack of a vehicle). As will be described in more detail herein, the support member 148 can improve the ability of the enclosure assembly 100 to interface with users, racks, vehicles, or other items.

Referring to FIGS. 10A and 10B together, the support member 148 can couple to the body 102 so that the support member 148 extends along a portion of the outer surface 104 of the body 102. For instance, as shown in FIGS. 10A and 10B, the support member 148 can be coupled to the fourth side 128 of the body 102. The support member 148 can be disposed substantially centrally along the longitudinal axis of the body 102. Thus, as best seen in FIG. 10A, the support member 148 can be positioned in-line with the second compartment 114 and spaced away from the first and second ends 108, 110 of the body 102. In some instances, it can be beneficial to position the support member 148 centrally along the body 102, as the bindings of the skis 10 can then overlap with the support member 148 when the skis 10 are disposed within the interior 106. In this arrangement, the bindings of the skis 10, which can be the heaviest of the part of the skis 10, can be better supported by the support member 148. Additionally, the overall handling of the enclosure assembly 100 can be improved, as the enclosure assembly 100 can interface with a user along the support member 148 (e.g., see FIG. 3C), and thus, the support member 148 can provide additional padding to the user along the bindings of the skis 10.

As shown in FIG. 10B, the support member 148 can define at least a first side 150, which can be externally exposed when the support member 148 is coupled to the body 102. The first side 150 can extend along the longitudinal axis between a first end 152 and a second end 154, and, in some arrangements, define a portion of the fourth side 128 of the body 102. In some examples, the first side 150 can be configured to extend a specific length (e.g., the distance between the first and second ends 152, 154). For example, the first side 150 can be configured to extend the average distance between crossbars of a vehicle roof rack, the length of the second compartment 114, the average length of ski bindings, or some other distance (e.g., about 1, 2, 3, 4 feet, etc.). Additionally, the first side 150 can be configured to extend a specific width, including, for instance, at least half the width of the second compartment 114 or the average width of ski bindings. Configuring the support member 148 to have a length and width as specified herein can help improve the ability of the enclosure assembly 100 to interface with a user, vehicle, or some other object. For example, the increased length can ensure the support member 148 spans the length of the bindings of the skis 10 to increase comfort and prevent damage to the skis 10, while the increased width can improve the rigidity of the enclosure assembly 100.

Referring to FIGS. 10A and 10B, the first side 150 of the support member 148 can define a first contour 156. The first contour 156 can be configured to interface with one or more objects or surfaces, such as the back (or other portion, e.g., the side) of a user or a portion of a vehicle (e.g., a roof rack). For instance, in some arrangements, the first contour 156 can be curved so that the first side 150 can better conform to a back of a user. In other arrangements, the first contour 156 can be substantially planar, so that the first side 150 can better conform to a vehicle or storage rack.

FIG. 10C illustrates a cross-sectional top view of the enclosure assembly 100. As shown in FIG. 10C, the support member 148 can define a second side 158. The second side 158 can be positioned opposite the first side 150 (see FIGS. 10A, 10B) so that the support member 148 defines a thickness that extends between the first and second sides 150, 158. In some instances, and as shown in FIG. 10C, the support member 148 may not be exposed within the interior 106 of the body 102. In other instances, however, the support member 148 can be configured so that at least a portion of the second side 158 is exposed within the interior 106. In either case, or otherwise, the second side 158 of the support member 148 can define a second contour 160 that is configured for interfacing with equipment (e.g., the skis 10) that are disposed within the interior 106. As one example, the second contour 160 can be substantially planar, which can provide additional padding for the binding of the skis 10 disposed within the interior 106. As another example, the second side can be especially shaped to conform to the bindings of skis 10. In some arrangements, various fasteners can be coupled to the support member 148 from within the interior 106 and can help secure the skis 10 to the support member 148 from within the interior 106. For example, as shown in FIG. 10C, multiple straps 163 can be coupled to the support member 148 from within the interior 106, with the straps 163 being configured to couple to the skis 10 (or other object) and secure the skis 10 within the interior 106.

It should be appreciated that the support member 148 can be configured in arrangements other than as illustrated in FIG. 10A-10C. As one example, the support member 148 can be integrated with the body 102 (e.g., integrated with the fourth side 128). As another example, the support member 148 can be disposed within the interior 106 so that the support member 148 is not externally exposed. As another example, the enclosure assembly 100 does not include a support member 148 as shown, but instead includes additional material along the fourth side 128 to increase the padding of this fourth side 128 and to increase the rigidity. Additionally, other portions of the body 102, such as the inner lining 111 within the second compartment 114, can define a contour that is configured for interfacing with equipment stored within the interior 106 or with some other person or object. These and other arrangements of the support member 148 are within the scope of the present disclosure.

In some examples, the enclosure assembly 100 can include a MOLLE system (or other fastening device), which can be used to interact with a strap, such as the strap assembly 101 (shown in FIG. 1) to help carry the enclosure assembly 100. As shown in FIG. 10B, the enclosure assembly 100 can include a MOLLE system 161 that is disposed adjacent to the support member 148. The MOLLE system 161 can extend along at least a portion of the length of the support member 148 and along more than one side of the support member 148. Configuring the MOLLE system 161 in this manner can allow for the support member 148 to be positioned along the back of a user when the user utilizes the enclosure assembly 100 as a backpack (see, e.g., FIG. 3C). Additionally, by positioning the MOLLE system 161 to extend along the sides of the support member 148, the support member 148 can provide additional structural support to the enclosure assembly 100 which can help the enclosure assembly 100 maintain its shape in use. In other arrangements the MOLLE system 161 can be positioned at other locations along the body 102, in addition to, or in lieu of, along the one or more sides of the support member 148.

In some arrangements, several portions of the enclosure assembly 100 can be configured to interface with users and other objects. As one example, each of the first, second, third, and fourth sides 118, 124, 126, 128 can be configured to interface with users or other objects (e.g., such as the vehicle 20, roof rack 22, etc.). For instance, at least a portion of each of the first, second, third, and fourth sides 118, 124, 126, 128 can be substantially planar. Configuring at least a portion of the first, second, third, and fourth sides 118, 124, 126, 128 to be substantially planar can allow for these planar portions to interface with a storage rack (e.g., a roof rack 22 of a vehicle 20). Additionally, because the first, second, third, and fourth sides 118, 124, 126, 128 can each include a substantially planar portion, the body 102 can be supported at these planar portions with or without skis 10 being disposed in the interior 106. Thus, in some examples, the extension sections 132 do not interfere with supporting the enclosure assembly 100 by the first, second, third, or fourth sides 118, 124, 126, 128.

FIG. 10A illustrates a first planar portion 162 and a second planar portion 164 formed on the body 102 of the enclosure assembly 102. The first and second planar portions 162, 164 can each define a substantially planar surface for interfacing the enclosure assembly 100 with an object, such as a roof rack 22 of a vehicle 20. As shown in FIG. 10A, the first and second planar portions 162, 164 can be formed on the first side 118 of the body 102. The first and second planar portions 162, 164 can extend along at least a portion of the first and third compartments 112, 116 and can be substantially in-line with one another. Additionally, as shown in FIG. 10A, the first and second planar portions 162, 164 can be spaced apart from the support member 148 and closer to the first and second ends 108, 110 of the body 102. By positioning the first and second planar portions 162, 164 in this manner, the stability of the enclosure assembly 100 can be improved when the enclosure assembly 100 is positioned on the roof rack 22 of a vehicle 20.

While the illustrated embodiment shows the first side 118 as including a first planar portion 162 and a second planar portion 164, other portions of the body 102 can include a planar portion in addition to (or in lieu of) the first side 118. As one example, the second side 124 can include one or more planar portions, including planar portions that mirror the first and second planar portions 162, 164 of the first side 118. As another example, the fourth side 126 can define a first planar portion that extends between the first end 108 of the body 102 and the first end 152 of the support member 148 and a second planar portion that extends between the second end 110 of the body 102 and the second end 154 of the support member 148. As another example, the third side 124 can define a planar portion that extends the length of the entire third side 124. These and other arrangements of the body 102 are within the scope of the present disclosure.

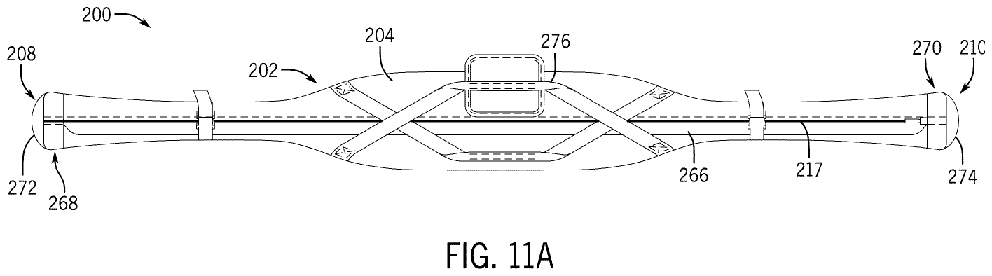

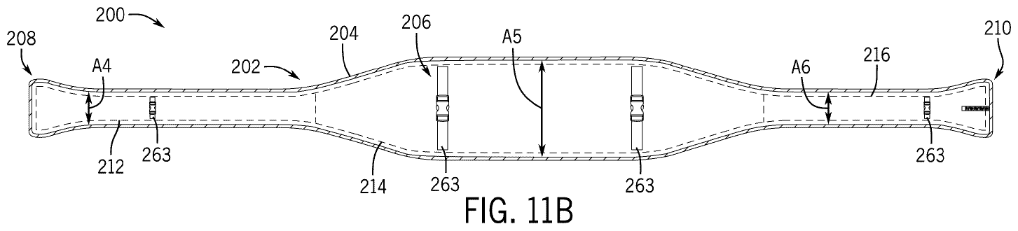

In some examples, it may be desirable to utilize an enclosure assembly that can secure skis 10 with minimal adjustments. FIGS. 11A to 14B illustrates one example of an enclosure assembly 200 which can secure skis 10 (and/or other equipment) with minimal adjustments. As shown in FIGS. 11A to 14B, the enclosure assembly 200 can be similar (or identical) to the enclosure assembly 100 in many respects and may operate in a similar fashion to the enclosure assembly 100. Accordingly, similar reference numerals between the enclosure assembly 100 and the enclosure assembly 200 are used to reference similar features, with the reference numbers for the enclosure assembly 200 being in the 200 series. These similar reference numbers can be used to indicate a similar (or identical) feature between the enclosure assembly 100 and the enclosure assembly 200, unless otherwise indicated herein or otherwise apparent from the drawings.

Referring to FIGS. 11A and 11B, a top view and cross-sectional view of the enclosure assembly 200 are illustrated. As shown in FIGS. 11A and 11B, the enclosure assembly 200 can include a body 202 that defines an outer surface 204 and an interior 206. The interior 206 can be configured to receive an item within (such as the skis 10), while the outer surface 204 can enclose the interior 206 and provide suitable protection to the interior 206 and any equipment positioned within. The interior 206 of the body 202 can include one or more compartments for storing an item. For instance, as shown in FIG. 11B, the body 202 can define first, second, and third compartments 212, 214, 216 that are positioned along the length of the body 102 and between the first and second ends 208, 210. In the illustrated embodiment, the first, second, and third compartments 212, 214, 216 can be arranged in series and can define a single internal volume that encompasses the entire interior 206. Each compartment 212, 214, 216 can have a specific cross-sectional area that can be different than (or similar to) a cross-sectional area of a separate compartment 212, 214, 216. For instance, as shown in FIG. 11B, the first compartment 212 can have a first cross-sectional area A4, which can be smaller than a second cross-sectional area A5 of the second compartment 214, but about substantially the same size as a third cross-section area A6 of the third compartment 216. By varying the cross-sectional areas of the first, second, and third compartments 212, 214, 216, the body 202 can be configured to conform better to skis 10 (or other objects) disposed within the interior 206, as the size of the cross-sectional areas A4, A5, A6 can correspond to the size of skis 10 along the length of the skis 10.

To provide access to the interior 206, the body 202 can define an opening that can extend the length of the body 202. This opening can be closed off with a closing device 217. In the illustrated embodiment, the closing device 217 is shown as a zipper that is coupled to the outer surface 204 of the body 202. In some examples, the enclosure assembly 200 can provide protection to the closing device 217. For instance, as shown in FIG. 11A, the body 202 can define a flap 266 which can extend alongside the closing device 217. The flap 266 can fold over the closing device 217 to shield the closing device 217 from the surrounding environment. This arrangement can improve the durability of the closing device 217 as the closing device can be prone to damage from the weather and chemicals (e.g., road salts) commonly used around ski resorts.

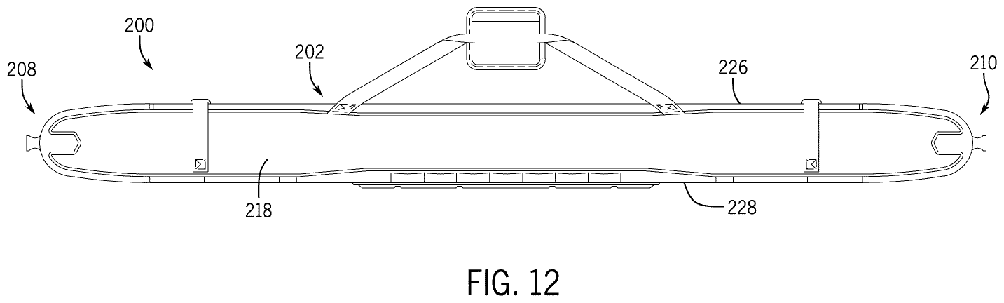

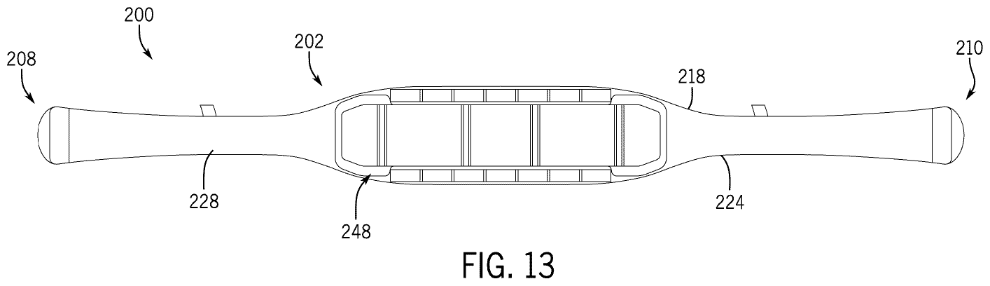

FIGS. 12 and 13 illustrate a side and bottom view, respectively, of the enclosure assembly 200. Referring to FIGS. 11A to 13 together, in some arrangements, the body 202 can be formed from a lightweight and durable material. For example, the body 202 can be formed from ripstop nylon or other suitable material (ripstop polyester, Cordura nylon, etc.). In some of these examples, each side of the body 202 can include ripstop nylon or other suitable material. For instance, each of the first side 218, second side 224, third side 226, and fourth side 228 can be formed primarily of (or entirely from) ripstop nylon. Forming the body 202 from this material (or other suitable material) can render the body 202 more resistant to damage (e.g., tearing) from the skis 10 and the surrounding environment without hampering the overall mobility of the enclosure assembly 200.

In some arrangements, forming the body 202 from ripstop nylon (or other material) can increase the rigidity of the body 202. This increased rigidity can lead to the first, second, and third cross-sectional areas A4, A5, A6 remaining substantially unchanged in size irrespective of whether skis 10 are positioned within the interior 206. Thus, in some instances, the first, second, third, and fourth sides 218, 224, 226, 228 of the body 202 do not substantially bow outwards (if at all) in response to skis 10 being placed within the interior 206. Arranging the body 202 in this manner can help the body 202 to maintain its shape when in use. Other portions of the enclosure assembly 200 can increase the rigidity of the body 202 and thereby help the body 202 maintain its shape during use. For instance, the support member 248 coupled to the fourth side 228 of the body 202 and can further increase the rigidity of the body 202.

To help the enclosure assembly 200 secure skis 10 within the interior 206 and limit the skis 10 from moving when stowed within, the enclosure assembly 200 can include several straps 263 positioned within the interior 206. For instance, as shown in FIG. 11B, the enclosure assembly 200 can include four straps 263 positioned along the length of the body 202. These straps 263 can be configured to couple to the skis 10 and hold the skis 10 in place within the interior 206.

In some examples, the body 202 can be reinforced at certain locations along its length to increase the durability of the enclosure assembly 200 and to provide additional protection to the skis 10 within the interior 206. For instance, as shown in FIG. 11A, the body 202 can include a first reinforced portion 268 at the first end 208 of the body 202 and a second reinforced portion 270 at the second end 210 of the body 202. By positioning the first and second reinforced portions 268, 270 at the first and second ends 208, 210 of the body 202, the first and second reinforced portions 268, 270 can be positioned near (or adjacent to) the ends of the skis 10 when the skis 10 are positioned within the interior 206. Thus, the first and second reinforced portions 268, 270 can provide additional protection to the ends of skis 10 and can help prevent the ends of skis 10 from puncturing the body 202. Additionally, by positioning the first and second reinforced portions 268, 270 at the first and second ends 208, 210, the body 202 can be safely dragged and can safely rest on its end without damaging the skis 10 or the enclosure assembly 200.

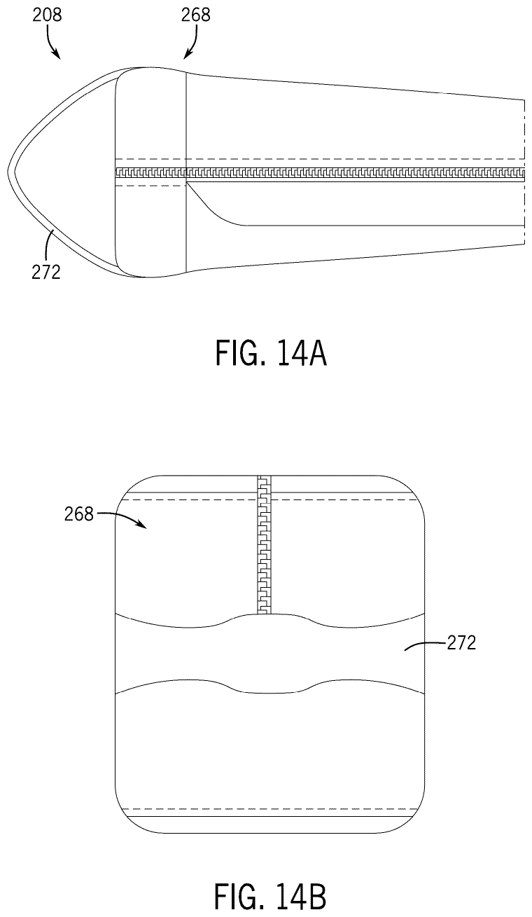

FIG. 14A illustrates a partial closeup top view of the first end 208 of the body 202, and FIG. 14B illustrates an end view of the first end 208. As shown in FIGS. 14A and 14B, the first reinforced portion 268 can extend around the first end 208 of the body 202 and can, in some cases, define an end cap for the body 202. In some arrangements, the first reinforced portion 268 (and second reinforced portion 270) can be a suitable reinforcing material (e.g., padding) that is coupled to the outer surface 204 and/or interior 206 of the body 202. In other arrangements, the first reinforced portion 268 can be defined by a thicker portion of the body 202. These arrangements of the first reinforced portion 268 can allow for the first reinforced portion 268 to provide suitable protection to the ends skis 10 and can help guard against the skis 10 puncturing the body 202 at the first end 208. While the illustrated embodiment of FIGS. 14A and 14B show only the first reinforced portion 268, the second reinforced portion 270 can be arranged similarly to the first reinforced portion 268. For instance, the second reinforced portion 270 can define an end cap at the second end 210 of the body 202, and can be configured to provide suitable protection to the ends skis 10 and can help guard against the skis 10 puncturing the body 202 at the second end 210.

The enclosure assembly 200 can include several handles which can help a user with maneuvering the enclosure assembly 200. For instance, referring again to FIG. 11A, the enclosure assembly 200 can include a first handle 272 at the first end 208 of the body 202, a second handle 274 at the second end 210 of the body 202 and a third handle 276 coupled to the strap assembly 201. The first, second, and third handles 272, 274, 276 can provide a user with a variety of locations to grip the enclosure assembly 200.

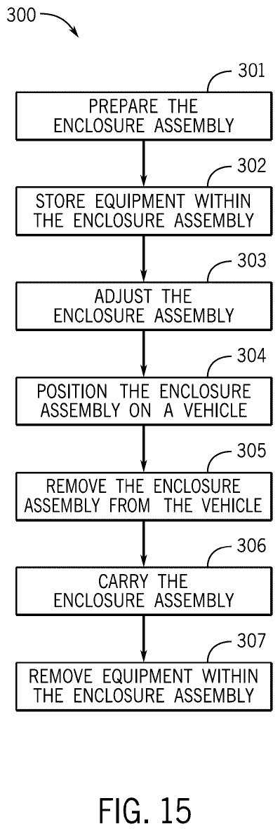

With reference to FIG. 15, an example method 300 of using an enclosure assembly will now be described. The method 300 can be utilized with any enclosure assembly described herein, including the enclosure assembly 100 and the enclosure assembly 200. At step 301, the method 300 begins with preparing the enclosure assembly to receive equipment (e.g., skis 10). The enclosure assembly can include a body (e.g., the body 102, the body 202) having an outer surface (e.g., an outer surface 104, outer surface 204) which encloses an interior (e.g., the interior 106, interior 206). The body can define an opening that provides access to the interior, and the opening can be closed off with a closing device (e.g., the closing device 117, closing device 217). In some arrangements, preparing the enclosure assembly to receive equipment can include opening the enclosure assembly so that the interior is accessible and so the equipment can be stored within. Additionally, in some arrangements, preparing the enclosure assembly to receive equipment can include adjusting (or modifying) the enclosure assembly. For instance, the enclosure assembly can be lengthened so that it can be easier to position equipment of a particular size within the interior, or the enclosure assembly may be shortened so that the equipment can fit tightly once disposed within the interior.

At step 302, the method 300 continues with storing equipment within the enclosure assembly. To store equipment within the enclosure assembly, the equipment can be placed directly within the interior while the interior is accessible. In some examples, the equipment can span the length of the interior once disposed within the interior, including across several compartments (e.g., the first, second, and third compartments 112, 114, 116, 212, 214, 216). Thus, in some arrangements, storing equipment within the enclosure assembly can include placing equipment within the first, second, and third compartments.

At step 303, the method 300 optionally includes adjusting the enclosure assembly. With the equipment disposed within the interior, the enclosure assembly can be adjusted to secure the equipment within the interior. As one example, the enclosure assembly can include one or more fasteners (e.g., the straps 163), which can hold the equipment in place within the interior. Thus, in some arraignments, adjusting the enclosure assembly can include fastening the equipment within the interior. As another example, the body of the enclosure assembly can be adjusted to fit the equipment more tightly. This adjustment can include expanding (or contracting) the sides (e.g., the first and second sides 118, 124) of the body around certain portions of the equipment. Thus, in some instances, the enclosure assembly will adjust automatically to conform to the equipment within the interior. Adjusting the enclosure assembly can also include lengthening (or shortening) the body with one or more extension sections (e.g., the extension sections 132). In some examples, the enclosure assembly can be adjusted so that the enclosure assembly provides a tight, secure fit around the equipment. In other examples, the enclosure assembly can be configured to provide a tight, secure fit without adjusting through expanding or contracting sides or extension sections. For example, the enclosure assembly can be sized to provide a tight, secure fit to skis of a particular size. In any case, once the equipment is secured within the interior, the closure device can be adjusted so that the opening is closed off.

At step 304, the method 300 optionally includes positioning the enclosure assembly on a vehicle. With the equipment secured within the interior, the enclosure assembly can be positioned on a vehicle so that the equipment can be transported to a desired location. In some instances, the enclosure assembly can be configured to interface with a vehicle. For instance, the enclosure assembly can include several portions that are substantially planar, including a first planar portion (e.g., the first planar portion 162) and a second planar portion (e.g., the second planar portion 164). The first planar portion can be positioned on a first rack of the roof rack, while the second planar portion can be positioned on a second rack of the roof rack. The first and second planar portions can be substantially parallel and substantially in-line, which can improve the stability of the enclosure assembly as it is positioned on the vehicle. In some arrangements, the enclosure assembly can interface with other storage systems within a vehicle. With the enclosure assembly positioned on the vehicle, the enclosure assembly can be fastened to the vehicle to secure the enclosure assembly in place for the duration of the trip.

At step 305, the method 300 optionally includes removing the enclosure assembly from the vehicle. If the enclosure assembly is positioned on a vehicle, the enclosure assembly can be removed from the vehicle so that the enclosure assembly is no longer interfacing with the vehicle. In some examples, to remove the enclosure assembly from the vehicle, the enclosure assembly can be unsecured so that the enclosure assembly is free to move. For instance, the enclosure assembly can be unsecured from a roof rack of a vehicle (or other storage system) so that the enclosure assembly can be carried away.

At step 306, the method optionally includes carrying the enclosure assembly. To carry the enclosure assembly, a user can rely on the handles provided on the body to carry the enclosure assembly as needed. In some arrangements, the enclosure assembly can be carried with a strap assembly (e.g., the strap assembly 101). The strap assembly can be arranged so that the person can carry the enclosure assembly in an over-the-shoulder manner. Additionally, the strap assembly can be arranged so that the user can carry the enclosure assembly in a backpack-like manner. When carrying the enclosure assembly as a backpack, the enclosure assembly can be arranged such that a support member (e.g., the support member 148, support member 248) is positioned along the back of the user. The support member can be aligned with the second compartment and can provide additional padding from the equipment positioned within the second compartment. Additionally, to improve comfort and ease of use, in some arrangements the support member can include a contour (e.g., the first contour) which can be shaped to conform to the back of a user or other surface.

At step 307, the method optionally includes removing the equipment within the enclosure assembly. To remove the equipment, the closure device can first be adjusted to open the opening and provide access to the interior. Any fastening mechanisms securing the equipment within the interior can be uncoupled from the equipment. With the enclosure assembly opened, and the equipment unsecured, a user can grab the equipment and manually remove the equipment from the enclosure.

Various example embodiments of the disclosure are discussed in detail herein. While specific implementations are discussed, it should be understood that this description is for illustration purposes only. A person skilled in the relevant art will recognize that other components and configurations may be used without parting from the spirit and scope of the disclosure. Thus, the included description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

Directional terms such as “top,” “bottom,” “upper,” “lower,” “vertical,” “horizontal,” “lateral,” “side,” “above,” “below,” etc. in the present disclosure is meant to provide orientation to the reader with reference to the drawings. Such language is not intended to require a particular orientation of the component(s) or to impart orientation limitations into the claims.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods, and their related results according to the example embodiments of the present disclosure are described herein. Note that titles or subtitles may be used in the examples for the convenience of a reader, which in no way should limit the scope of the disclosure.

Additional features and advantages of the disclosure are set forth in the description, and may be in part obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the description and appended claims.

Terms such as “coupled,” “mounted,” “attached,” and the like should be understood to include both direct coupling, mounting, or attaching, as well as indirect coupling, mounting, or attaching through one or more intermediate components or features, unless otherwise modified by use of a term such as “directly” in connection with the coupling, mounting, or attaching.

Where appropriate, relative terms, such as “about,” “substantially,” and “approximately,” can be understood to incorporate standard tolerances. Where standard tolerances are unknown or disputed, relative terms can be understood to mean plus or minus 1%, 2%, 3%, 4%, or 5%. Where appropriate, relative terms can be understood to incorporate standard tolerances as one example and plus or minus 1%, 2%, 3%, 4%, or 5% as a second example.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. An enclosure for equipment, the enclosure comprising:
a body defining an outer surface and an interior, the body having a longitudinal axis extending between a first end of the body and a second end of the body opposite the first end, wherein the interior includes first, second, and third compartments disposed in series along the longitudinal axis, wherein the first compartment has a first cross-sectional area, the second compartment has a second cross-sectional area, and the third compartment has a third cross-sectional area, and wherein the second cross-sectional area is larger than the first and third cross-sectional areas; and
an opening extending across at least a portion of one of the first, second, or third compartments.

2. The enclosure of claim 1, wherein the first end of the body is flared.

3. The enclosure of claim 1, further comprising a reinforcing portion coupled to the first end of the body, wherein the reinforcing portion is configured to increase the thickness of the body at the first end.

4. The enclosure of claim 3, wherein the reinforcing portion surrounds the first end of the body.

5. The enclosure of claim 1, wherein the second compartment is adjustable between a first configuration, where the second compartment is empty, and a second configuration, where equipment is stored within the second compartment, and wherein the second cross-sectional area is larger in the second configuration than in the first configuration.

6. The enclosure of claim 1, wherein the second cross-sectional area varies across the length of the second compartment.

7. The enclosure of claim 1, wherein the body includes ripstop nylon.

8. An enclosure for equipment, the enclosure comprising:
a body defining an outer surface and an interior, the body having a longitudinal axis extending between a first end of the body and a second end of the body opposite the first end; and
a support member coupled to the body and defining a first side and an opposing second side, wherein the first side includes a first contour configured for interfacing with a surface, and wherein the second side includes a second contour for interfacing with the equipment, the second side being oriented towards the interior of the body.

9. The enclosure of claim 8, wherein the interior includes first, second, and third compartments disposed in series along the longitudinal axis, and wherein the support member is disposed along the length of the second compartment.

10. The enclosure of claim 9, wherein the first compartment has a first cross-sectional area, the second compartment has a second cross-sectional area, and the third compartment has a third cross-sectional area, and wherein the second cross-sectional area is larger than the first and third cross-sectional areas.

11. The enclosure of claim 9, wherein the outer surface of the body defines a first planar surface extending along at least a portion of the length of the first compartment, and wherein the planar surface is configured to interface with a roof rack.

12. The enclosure of claim 11, wherein the first planar surface is spaced apart from the support member.

13. The enclosure of claim 11, wherein the outer surface of the body defines a second planar surface extending along at least a portion of the length of the third compartment, and wherein the second planar surface is configured to interface with the roof rack.

14. The enclosure of claim 9, wherein the support member defines a width, and wherein the width extends across at least half of the width of the second compartment.

15. The enclosure of claim 8, wherein the support member is spaced apart from the first end of the body and the second end of the body.

16. A method for using an enclosure assembly, the method comprising:
preparing the enclosure assembly, wherein the enclosure assembly includes a body defining an outer surface and interior, the body having a longitudinal axis extending between a first end of the body and a second end of the body opposite the first, wherein the interior includes first, second, and third compartments disposed in series along the longitudinal axis, wherein the first compartment has a first cross-sectional area, the second compartment has a second cross-sectional area, and the third compartment has a third cross-sectional area, and wherein the second cross-sectional area is larger than the first and third cross-sectional areas;
storing equipment within the interior of the enclosure assembly; and
adjusting the enclosure assembly.

17. The method of claim 16, wherein storing equipment within the interior of the enclosure assembly includes positioning the equipment within at least a portion of the first, second, and third compartments.

18. The method of claim 16, wherein adjusting the enclosure assembly includes adjusting the length of the first compartment.

19. The method of claim 16, wherein adjusting the enclosure assembly includes increasing the second cross-sectional area.

20. The method of claim 16, further comprising positioning the enclosure assembly on a vehicle.
